(19) United States
(12) Patent Application Publication
(10) Pub. No.: US 2010/0182630 A1
(43) Pub. Date: Jul. 22, 2010

(54) Secure Printing

(75) Inventors: Neelu Jethani, Bangalore (IN); Nimish Thakkar, Bangalore (IN); Aniruddha Bhosekar, Bangalore (IN)

Correspondence Address: EDELL, SHAPIRO & FINNAN, LLC, 1901 RESEARCH BOULEVARD, SUITE 400, ROCKVILLE, MD, 20850, US

(73) Assignee: CISCO TECHNOLOGY, INC., San Jose, CA (US)

(21) Appl. No.: 12/408,051

(22) Filed: Mar. 20, 2009

(30) Foreign Application Priority Data
Jan. 22, 2009 (IN) 139/CHE/2009

(51) Int. Cl. G06F 3/12

(52) U.S. Cl. 358/1.15

(57) ABSTRACT

A method is described comprising associating (104) a first identifier with a print job, holding (106) the print job without it printing, and releasing (108) the print job to print when a device is activated to provide a second identifier and the second identifier is related to the first identifier. An apparatus is also described comprising a receiver (18) of a print job which is associated with a first identifier, and an interface to a device (22) which provides a second identifier. The receiver (18) is configured to initially hold the print job without it printing, and the receiver (18) is configured to cause the print job to be printed by a printer (20) when the device (22) is connected to the interface, the second identifier is obtained from the device (22) and the second identifier is related to the first identifier.

### CROSS REFERENCE TO RELATED APPLICATIONS

This application claims priority under 35 U.S.C. §119 to Indian Patent Application No. 139/CHE/2009 filed on Jan. 22, 2009, entitled “Secure Printing,” the entire contents of which are hereby incorporated by reference.

### TECHNICAL FIELD

The present disclosure relates generally to printing of documents.

### BACKGROUND

It is common for a printer to be shared amongst users in a workplace. In this situation multiple users send print jobs to the printer over a computer network and they collect the printouts of the print jobs after they have printed. It is not uncommon for a person who has sent a print job to the printer to inadvertently pick up another person's printed document(s). Sometimes it is desired to print sensitive or confidential information which is not intended to be viewed by other people who have access to the printer.

### BRIEF DESCRIPTION OF THE DRAWINGS

Example embodiments will be described in greater detail, by example only, with reference to the accompanying drawings, in which:

FIG. 1 is a schematic representation of an embodiment of a printer system;

FIG. 2 is a schematic flow chart of an embodiment of a method of printing;

FIG. 3 is a schematic message transfer diagram between an identification token and a print server of the embodiment of the printer system of FIG. 1; and

FIG. 4 is a flow diagram of an embodiment of a printer system.

### DESCRIPTION OF EXAMPLE EMBODIMENTS

### Overview

According to an embodiment there is a method comprising associating a first identifier with a print job, holding the print job without it printing, and releasing the print job to print when a device is activated to provide a second identifier and the second identifier is related to the first identifier.

Also according to an embodiment, there is an apparatus comprising a receiver of a print job which is associated with a first identifier, and an interface to a device which provides a second identifier. The receiver is configured to initially hold the print job without it printing, and the receiver is configured to cause the print job to be printed by a printer when the device is connected to the interface, the second identifier is obtained from the device and the second identifier is related to the first identifier.

According to another embodiment, there is a method comprising receiving a print job associated with a first identifier, holding the print job without it printing, and releasing the print job to print when a device is activated to provide a second identifier and the second identifier is related to the first identifier.

In another embodiment there is a method comprising associating a first identifier with each of a plurality of print jobs, holding each print job without it printing, and releasing those print jobs to print which have their respective first identifier related to a second identifier provided by a device when the device is activated to provide the second identifier.

In a further embodiment there is an apparatus comprising a print job receiver for receiving print jobs each associated with a first identifier, and an interface to a device which provides a second identifier, wherein the receiver is configured to initially hold the print jobs without printing them, and wherein the receiver is configured to cause those print jobs to be printed which have their respective first identifier related to the second identifier provided by the device when the device is connected to the interface and the device provides the second identifier.

In a further embodiment there is a device which is arranged to provide a second identifier when activated, wherein the second identifier is such that a print job which is being held from printing is released to print when the second identifier is related to a first identifier.

### Example Embodiments

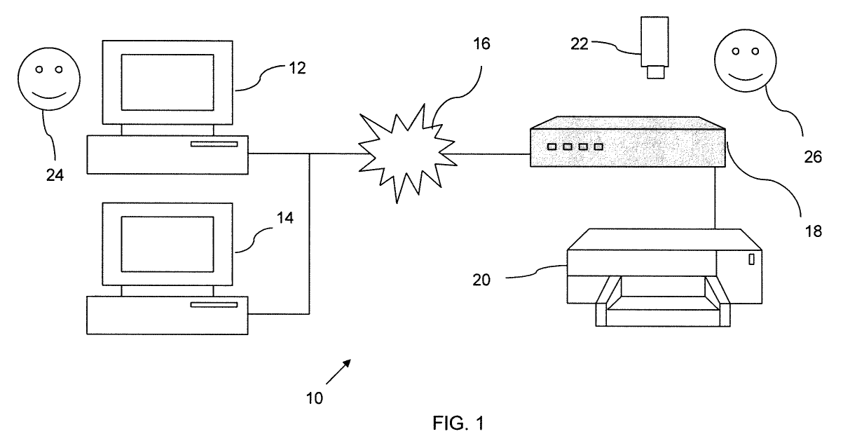

Referring to FIG. 1 there is shown a printer system 10 which comprises one or more client devices 12 and 14, a network 16, a print job receiver, and a printer 20. In an embodiment the print job receiver is a print server 18. The client devices 12 and 14 may be in the form of personal computers. Client devices 12, 14 may be other devices capable of interfacing with the network 16, generating a print job and sending the print job to the print server 20 over the network 16, such as a portable computing device, or other client device. The network 16 may be, for example, a local area network, a wide area network, a virtual private network, or a wireless network, of suitable form and may include the Internet, or may be any other network. The print server 18 may be in the form of a router component of the network 16. The print server 18 is able to receive print jobs from the client machines 12, 14 and control the printing of the print jobs by the printer 20. Thus the print server 18 may operate as a print job controller. Other forms of print job controller may be used which are not necessarily a print server. Other forms of print job receiver may be used which are not necessarily a print server.

The print server 18 forms part of the network route of the print job between the client device 12, 14 and the printer 20. In an embodiment the print server 18 is in close proximity to the printer 20. In an alternative embodiment the print server 18 is physically housed in the printer 20.

FIG. 1 shows a user 24 using client device 12. FIG. 1 also shows a user 26 in possession of a device 22 which is able to interface with the print server 18. In the case of there being more than one user 26, each user 26 may have their own personalized device 22.

The user 24 is able to create a print job from one of the client devices, in this case client device 12, by executing a print command. For example, a printer icon may be selected in respect of, for example, a document in a word processing application, a spread sheet in a spread sheet application or a web page on a web browser application. Numerous other computer applications may be used which will have a print command facility for printing a desired document. The print command may be executed by entering a text print command into a terminal.

Selection of the printer icon, or some other execution of another print command will generate a print job. Prior to creating the print job, selection of the print command may bring up a print job window which allows the user 24 to select the printer 20. Often a number of printers may be available to print to and the printer 20 is selectable from the possibilities. The user 24 may have a default printer automatically selected. The print job window may allow the user to select or enter the identity of the user 26 and provide other parameters for the print job, such as whether the printing is to be double sized, the number of pages etc. In the case of a text print command, an argument of the print command may include the identity of the user 26 or a representation of the identity of the user 26. In an embodiment the print job may be classified as a “secure printing” print job or “non-secure printing print job. In this embodiment the facility to select the identity of the user 26 may be enabled when a “secure printing” option is activated. Secure printing may be selected by, for example, checking a check box or radio button.

In an embodiment the user 24 may be presented with a plurality of identities to select user 26 from. The user 26 may be the same as user 24 or different person. The default identity of the user 26 may be user 24. The client device 12 may automatically be aware of the identity of the user 24 by virtue of a login identity. In an embodiment selection of the identity of the user 26 creates a default selection of the printer 20 from a plurality of available printers to which the print job is sent. An alternative printer may be selected by the user 24 instead of keeping the default printer. This enables the printer closest to the user 26 to be the default option, but also allows this to be manually changed.

In this embodiment, user 26 has the device 22 in their possession and is able to interface it with the print server 18. Typically the device 22 will have a universal serial bus (USB) interface (typically a male connector) which is able to connect to an interface on the print server 18 (typically a female connector). When the device 22 is interfaced with the print server 18 device 22 is activated so that information contained within or generated by the device 22 can be transferred to the print server 18. Other forms of interface may be used, such as an electrical interface, for example an RS 232 serial interface or an IEEE 1394 interface, or another type of interface, such as a wireless interface. The wireless interface may be activated, for example, by pressing a button on the device 22. The act of connecting the device interface to the print server interface or some other action may cause the device 22 to activate so as to communicate with the print server 18.

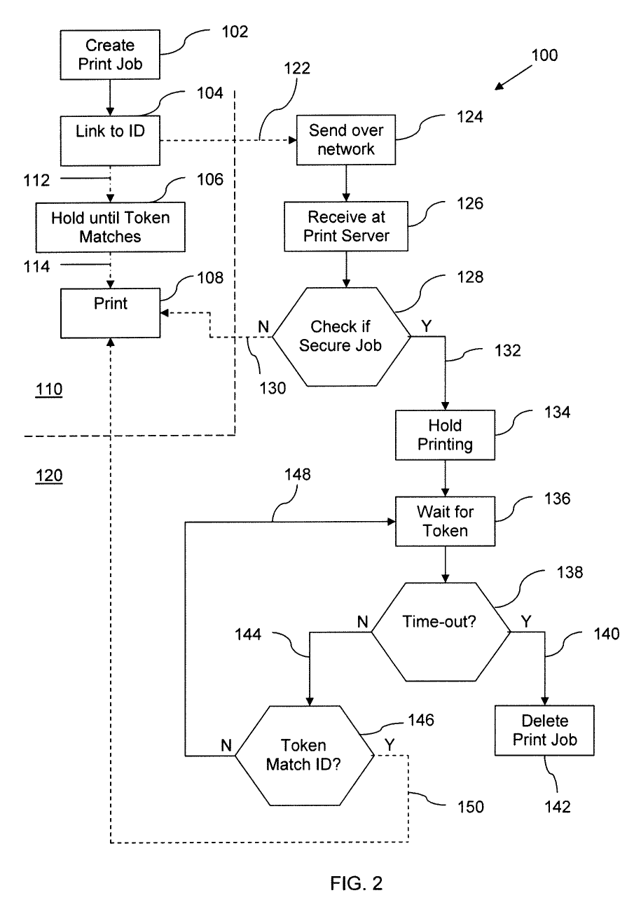

Referring to FIG. 2, an embodiment of a method 100 of printing is shown. The method 100 includes simple method 110 and an optional more detailed method 120. The more detailed method 120 replaces step 106 of the simple method 110.

In the simple method 110, the user 24 creates a print job at step 102. When creating the print job a relationship is created between the print job and an identifier of the user 26 at step 102. The relationship is created by user 24 between the print job and user 26 such that user 24 wishes only user 26 to be able to obtain the printout as a result of printing of the print job. As mentioned above, user 26 may be the same as user 24 or user 26 may be a different user to user 24. In one example the user 24 wishes to print a confidential document. In this example user 26 is the same as user 24, so the identifier of user 26 is an identifier of the user 24. The user 24 can then go to the printer 20 in order to retrieve the document. In another example the user 24 wishes to have a different person to be able to collect the document. Say it is a confidential report to board members, including user 26.

The user 24 links the identifier of user 26 to the print job. The print job is then sent to the print server 18, which at step 106 holds the print job until device 22 is interfaced with the print server 18, which in turn activates the device 22. Activation of the device 22 causes a representation of the identifier in the form of an identification token to be sent from the device 22 to the print server 18. Print server 18 determines whether the identification token is related to the linked identifier. In particular, in this embodiment, the form of relationship is that they are the same. Thus the print server 18 matches the identification token with the linked identifier. The print job is held until the token matches at 106. When the token matches, the print job is released at step 108 and the document is printed by the printer 20.

The more detailed method 120 will now be described with reference to FIGS. 2, 3 and 4. Again, the process starts by the user creating a print job at 102. This is equivalent to the user sending a command 302 to the client machine 12 in FIG. 4. Again, the user links an identifier of user 26 to the print job at step 104. For example, if the user wishes to collect the print job him or herself, and the user's name is for example, “Fred”, the user will link the print job to a representation of Fred, this might be the name Fred or it could be a representative number or some other representative code, for example “123456” or any other identifier. In an embodiment the user 24 may select an alias (for example Fred) which the client device 12 or print server 18 will substitute for another identifier of the user 26 (for example “123456”). The representative name, number or code (referred to as a required identity representation) is chosen such that when the device 22 is interfaced with the print server 18, this required identity representation or a precursor of that representation will be provided to the print server 18 by the device 22. In particular if there are multiple users that are able to collect securely printed documents it is desirable for the required identity representation that corresponds to the personalized device 22 of the specific user 26 be selected.

In the case of the device 22 providing a precursor representation to the print server 18, the print server 18 may manipulate the precursor representation, once received, to generate the required identity representation, for example, by decoding/decrypting it. Alternatively an association may be recorded between each identification token sent by each device 22 when activated and the corresponding required identity representation. The recordation may occur in the client device 12, in the print server 18 or in a networked repository. In the detailed method arrow 122 is undertaken instead of arrow 112. The print job along with its linked required identity representation, is sent over the network 16 at step 124. The print job is received at the print server 18 at step 126. Sending the print job from the client machine 12 to the print server 18 is represented by arrow 304 in FIG. 4.

The user 24 may have decided to not link an identity representation with the print job, that is the user 24 may have decided the print job is “non-secure”. At step 128 the print server 18 checks as to whether the print job has been linked to an identity representation, if it is not linked then it is not regarded as a secure print job and arrow 130 can be taken. In this case the print job is printed by printer 20 at step 108.

However, if the print job is linked to an identity representation, then the print job is regarded as a secure print job and arrow 132 is taken. The print server 18 holds the print job at step 134 and waits for the device 22 to be interfaced with the print server 18 at step 136. This is represented by arrow 306 in FIG. 4. The print server 18 has an allocated amount of time in which it will wait for the interface of the device 22 to the print server 18. This may for example 2 hours, but any appropriate length of time can be used. If the time passes without the correct device 22 being interfaced to the print server 18 then arrow 140 is taken and the print server 18 deletes the print job 142. Optionally a message may be passed back from the print server 18 to the client machine 12 indicating that the print job timed out or is about to time-out and that the print job has been or will be deleted.

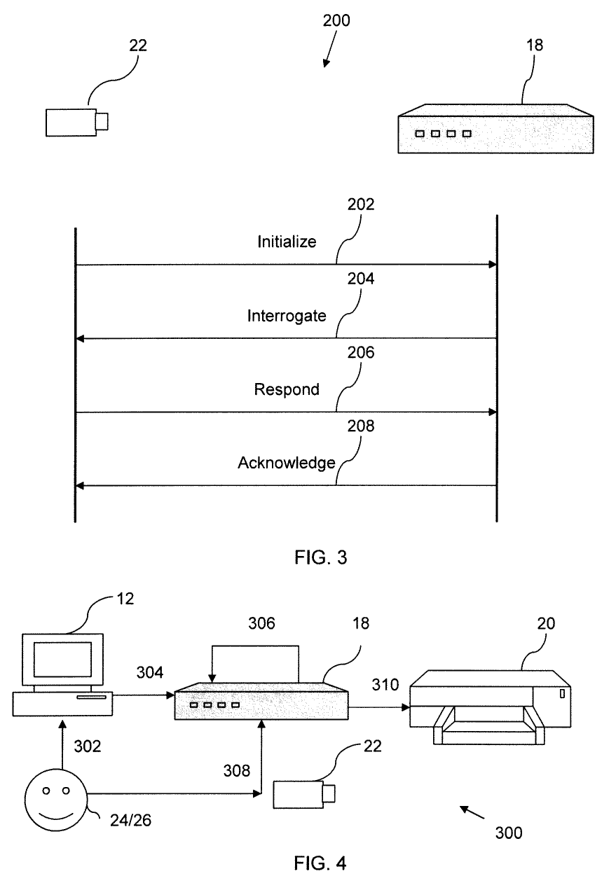

If a device 22 is interfaced to the print server 18 arrow 144 is taken. This is equivalent to arrow 308 in FIG. 4. The device 22 is activated and sends an initialisation message 202 in FIG. 3 to the print server 18 which identifies it as a device that the print server 18 can communicate with. The print server 18 sends an interrogation message 204 to the device 22. Device 22 sends a response message 206 which includes an identification token which is received by the print server 18. The print server 18 may optionally send an acknowledgement message 208 to the device 22. The identification token may include the representation of the identity of user 26 such as “Fred” or “123456”. Alternatively the identification token may be a precursor of the representation. For example, the identification token may be encrypted and the encrypted token is sent where the print server 18 is able to remove the encryption and obtain the identity representation. Alternatively the identity representation may be a precursor of the identity token. The received identity representation from the identification token is compared to the required identity representation linked to the print job to determine if they are related. If the representations are not related (for example they do not match) the process returns by arrow 148 to waiting for the correct token 136. It may be that the device 22 has been inserted for a different purpose than printing the print job sent by user 24 and does not have the correct identity representation (or precursor) in the identification token. In this case some other process may execute until the device 22 is inserted which has the related identification token. In the event that the representations are related (for example if they match) arrow 150 is taken and the print server 18 releases the print job to the printer 20 for collection by the authenticated user 26. This is indicated by 310 in FIG. 4. In an embodiment once the device 22 is activated the print server 18 automatically determines whether the received identification token is related to the required identity representation and releases the print job to the printer 20 automatically without further involvement of the user 26.

In an embodiment where multiple print jobs are sent to the printer 20 and some of the print jobs are associated with different identity representations then only those print jobs associated with the identity representation corresponding to the identification token provided by the specific device 22 that is interfaced to the print server 18 will print. The other print jobs will wait until the correct specific device 22 is interfaced to the print server 18.

In an embodiment the print server 18 is associated with a group of one or more printers, but there may be other printers connected to the network 16. The association may be in the form of, for example, the group of printers being connected to the network 16 by the print server 18. The print job is released to print only when the print job is designated to one of the printers associated with the print server 18. That is, other printers on the network will not be caused to print a held print job by the device 22 being connected to print server 18. In a further embodiment, if the print server 18 is associated with a group of printers when the device 22 is connected to the print server 18, all of the printers to which the print server 18 is associated, will print those print jobs which have their respective required identifier representation related to the identification token received from the device 22.

The device may comprise a biometric reader, such as a finger print scanner. The device may be configured to take a biometric reading and use data from the biometric reading as, or a derivation of, the data from the biometric reading as the identification token.

Each person (respective user 26) that is to collect secure printing will require their own personalized device 22 which has a unique representation of the identity of the respective user 26 or a precursor thereof. The device 22 may be an e-token device, such as an Aladdin™ e-token device. This allows the credentials of the user to be authenticated when the print server 18 is a Cisco router.

In an alternative embodiment the device may be housed in the printer 20 or the print server 18. The device may have an input device which receives an input that forms, or is a precursor to, the identification token. For example the device may have a biometric reader or a key pad for receiving an input from the user 26. Receipt of the input activates the device 22, which in turn sends the identification token to the print server 18.

In an embodiment Internet Printing Protocol (IPP) can be used to send print jobs to the print server 18. The IPP has support for a number of attributes. In this embodiment, an attribute can be used in the IPP message which indicates that “e-token-security-desired” along with the representation of the identity of the user 26. The IPP client implementation in the print server 18 can be extended such that when a job is submitted for printing, along with other attributes in the print job request, the value of the e-token-security-desired is also sent. The value of this attribute can either be true or false.

For each printer controlled by the print server 18, two or more queues can be maintained. One of these queues can be for regular print jobs and the other can be for jobs which require secure printing. A job scheduler process can be implemented by print server 18 which schedules the jobs for printing from these queues. Where a print job has the e-token-security-desired attribute set to false the print job can be allocated to the regular print jobs queue by the job scheduler and processed in the normal manner, such as a first come first serve order. When the e-token-security-desired attribute is set to true the print job can be allocated to the secure printing queue by the job scheduler.

When the client machine 12 has a spooler implementation, the print job data can be received and spooled by the print server 18. In the case of the print server 18 having a spooler-less implementation, the print job data will not be accepted from the client 12 but the connection be kept open. Where the print server 18 has a number of jobs in the print queues and the job scheduler process is currently processing jobs from the normal queue, the order of processing can be modified so that the scheduler completes the current print job and then starts processing print jobs belonging to the authenticated user 26 from the secure queue. When there are no more jobs from the user 26 in the secure queue or if the device 22 is removed from the print server 18, the job scheduler process can go back to processing print jobs in the regular queue.

In one embodiment a plurality of user identities can be linked to the print job. This may be achieved by automatically creating a print job for each user and linking the respective user identity with a respective one of the print jobs. In an embodiment the user identity is a class identity that applies to a group of users 26, such that any one of the members of the group will be able to collect the printed document by associating their device 22 with the print server 18.

The print server 18 will typically comprise a processor controlled by executable logic in the form of computer program instructions. The instructions will typically be stored in a non volatile memory, such as flash memory or an EEPROM. The instructions may be loaded wholly or partly into working RAM of the print server 18. The logic may also be stored on other forms on tangible media prior to loading into the print server 18. The logic is in a form that configures the processor to operate as described herein. The print server may comprise other hardware configured to cause it to operate as described herein.

The client devices 12 and 14 may also comprise a processor controlled by executable logic in the form of computer program instructions. The instructions will typically be stored in a non volatile memory, such as a hard disk drive. The instructions may be loaded wholly or partly into working RAM of the client device 12, 14. The logic may also be stored on other forms on tangible media prior to loading into the client device 12, 14, such as a CD, DVD, floppy disk, or flash memory.

Obtaining a separate printer for each user wishing to print sensitive or confidential information is therefore unnecessary.

Modifications and variations as would be apparent to a skilled person are intended to fall within the scope of this disclosure.

What is claimed is:

1. A method comprising associating a first identifier with a print job, holding the print job without it printing, and releasing the print job to print when a device is activated to provide a second identifier and the second identifier is related to the first identifier.

2. The method claimed in claim 1, further comprising creation of the print job, which comprises selecting the first identifier from a plurality of available choices.

3. The method claimed in claim 2, wherein the selected first identifier creates a default selection of a printer to which the print job is sent from a plurality of available printers.

4. The method claimed in claim 1, further comprising creation of the print job, which comprises selecting to print the print job by secure printing prior to association of the first identifier with the print job.

5. The method claimed in claim 1, wherein activation of the device comprises connecting the device to a print job controller.

6. The method as claimed in claim 5, wherein the print job controller is associated with one or more printers, and the print job is released to print only when the print job is designated to one of the printers that the print job controller is associated with.

7. The method claimed in claim 1, wherein the first identifier is related to the second identifier when one or more of the following applies: the first identifier is the same as the second identifier; the second identifier is a precursor of the first identifier; the first identifier is a precursor of the second identifier; or there is a recorded association between the first identifier and second identifier.

8. The method claimed in claim 1, further comprising allocating a personalized device to each person desiring to receive securely printed print jobs.

9. The method claimed in claim 1, wherein the second identifier is derived from a biometric reading of the user.

10. An apparatus comprising a receiver of a print job which is associated with a first identifier, and an interface to a device which provides a second identifier, wherein the receiver is configured to initially hold the print job without it printing, and wherein the receiver is configured to cause the print job to be printed by a printer when the device is connected to the interface, the second identifier is obtained from the device and the second identifier is related to the first identifier.

11. The apparatus as claimed in claim 10, wherein the interface forms part of a network router.

12. The apparatus as claimed in claim 10, wherein the receiver comprises a print server for controlling printing of the print job.

13. The apparatus as claimed in claim 10, wherein the receiver is configured to determine whether the first identifier is related to the second identifier.

14. The apparatus as claimed in claim 10, further comprising a plurality of devices each device able to be allocated to a distinct user and each device being configured to be activated to provide a respective second identifier when one of the devices is connected to the interface.

15. The apparatus as claimed in claim 10, further comprising a print job creator for creating the print job associated with the first identifier.

16. The apparatus claimed in claim 10, wherein the second identifier is a biometric reading taken by a biometric reader of the device.

17. The apparatus claimed in claim 10, wherein the device is housed in the printer.

18. The apparatus claimed in claim 10, wherein the device is mobile and is arranged to communicate with the interface when activated.

19. The apparatus as claimed in claim 10, wherein the device is a connectable electronic device configured to generate the second identifier and output the second identifier to the interface when the device is connected to the interface.

20. A method comprising associating a first identifier with each of a plurality of print jobs, holding each print job without it printing, and releasing those print jobs to print which have their respective first identifier related to a second identifier provided by a device when the device is activated to provide the second identifier.

21. An apparatus comprising a print job receiver for receiving print jobs each associated with a first identifier, and an interface to a device which provides a second identifier, wherein the receiver is configured to initially hold the print jobs without printing them, and wherein the receiver is configured to cause those print jobs to be printed which have their respective first identifier related to the second identifier provided by the device when the device is connected to the interface the device and provides the second identifier.

22. A method comprising receiving a print job associated with a first identifier, holding the print job without it printing, and releasing the print job to print when a device is activated to provide a second identifier and the second identifier is related to the first identifier.
